(19) United States
(12) Patent Application Publication
(10) Pub. No.: US 2017/0063820 A1
(43) Pub. Date: Mar. 2, 2017

(54) Performing Online Account Security Actions in Response to Sign-On and Sign-Off Events

(71) Applicant: Bank of America Corporation, Charlotte, NC (US)

(72) Inventors: William B. Belchee, Charlotte, NC (US); Elizabeth S. Votaw, Potomac, MD (US); Michael P. Lynch, Jacksonville, FL (US)

(21) Appl. No.: 14/839,117

(22) Filed: Aug. 28, 2015

(51) Int. Cl. H04L 29/06

(52) U.S. Cl. CPC H04L 63/08; H04L 63/20; H04L 63/0428

(57) ABSTRACT

According to one embodiment, a system includes a memory comprising instructions, an interface, and a processor communicatively coupled to the memory and the interface. The interface is configured to receive an indication of a sign-on event for a first application installed on a user device, and the processor is configured, when executing the instructions, to perform, in response to the sign-on event, one or more first account security functions.

### TECHNICAL FIELD

This disclosure relates generally to online account security, and more particularly to performing online account security actions in response to sign-on and sign-off events.

### BACKGROUND

Accessing online accounts using mobile applications may present certain security risks. For example, communications or local data associated with the mobile application may not be encrypted. This may allow for easier access to such data for unauthorized users, such as hackers. In addition, the local data associated with the mobile application may be stored on the mobile device long after the user has ended their session on the mobile application. This may also provide easier access to such data for unauthorized users.

### SUMMARY OF THE DISCLOSURE

In accordance with the present disclosure, disadvantages and problems associated with accessing an online account using a mobile application may be reduced or eliminated.

According to one embodiment, a system is provided that comprises a memory comprising instructions, an interface, and a processor communicatively coupled to the memory and the interface. The interface is configured to receive an indication of a sign-on event for a first application installed on a user device, and the processor is configured, when executing the instructions, to perform, in response to the sign-on event, one or more first account security functions.

According to one embodiment, a method is provided that comprises the steps of receiving an indication of a sign-on event for a first application installed on a user device, and performing, in response to the sign-on event, one or more first account security functions

According to one embodiment, a computer-readable medium comprising instructions is provided. The instructions are configured when executed to receive an indication of a sign-on event for a first application installed on a user device, and perform, in response to the sign-on event, one or more first account security functions

Technical advantages of certain embodiments of the present disclosure include securing a user device when online accounts are accessed using mobile applications, which may prevent the loss or misappropriation of sensitive data associated with the online account. Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example system comprising user devices accessing a server over a network;

FIG. 2 illustrates an example computer system in accordance with embodiments of the present disclosure;

FIGS. 3A-3C illustrate an example user device performing online account security actions in response to sign-on and sign-off events in accordance with embodiments of the present disclosure; and

FIG. 4 illustrates an example method for performing online account security actions in response to sign-on and sign-off events in accordance with embodiments of the present disclosure.

### DETAILED DESCRIPTION

The present disclosure describes systems and methods for performing online account security actions in response to sign-on and sign-off events. More particularly, a user device running a mobile application to access an online account may secure the user device based on the sign-on and sign-off events. For example, communications and local data associated with the mobile application may be encrypted when a user is logged into the mobile application. As another example, all local data associated with the mobile application may be deleted when a user signs out of the mobile application. For confirmation, notifications may be provided to a user of the user device indicating that the security actions have been taken, such as during or after the sign-on and sign-off events.

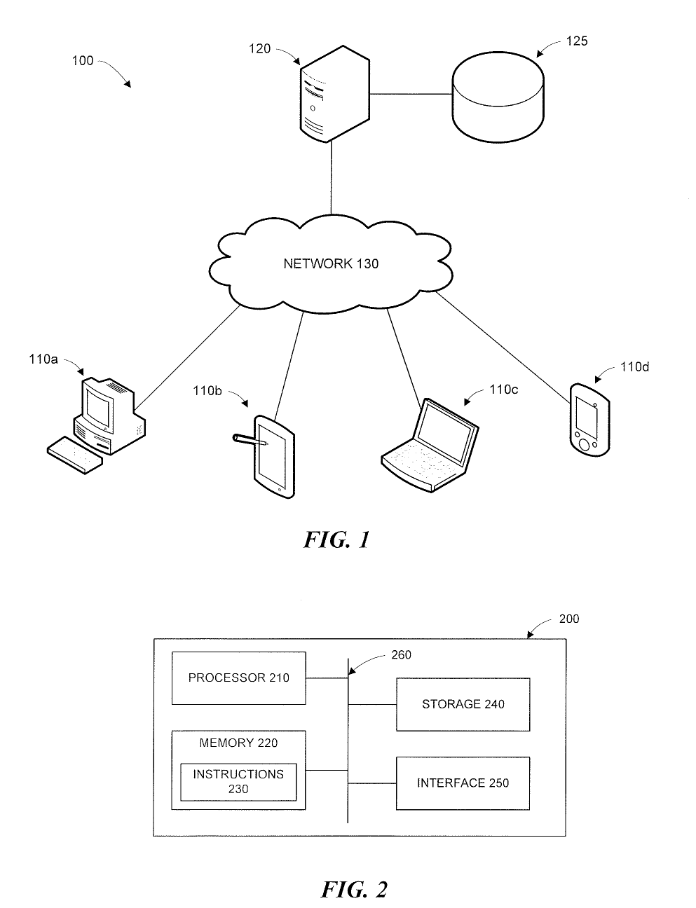

To facilitate a better understanding of the present disclosure, the following examples of certain embodiments are given. In no way should the following examples be read to limit, or define, the scope of the disclosure. Embodiments of the present disclosure and its advantages may be best understood by referring to FIGS. 1-4, where like numbers are used to indicate like and corresponding parts.

FIG. 1 illustrates an example system 100 comprising user devices 110 accessing server 120 over network 130. User devices 110 may include any suitable computing device that may be used to access one or more functions of server 120 through network 130. User devices 110 may include mobile computing devices with wireless network connection capabilities (e.g., wireless-fidelity (WI-FI), and/or BLUETOOTH capabilities). For example, user devices 120 may include laptop computers, smartphones, or tablet computers (such as tablet 110b, laptop 110c, and smartphone 110). User devices 110 may also include non-mobile devices such as desktop computers (such as desktop 110a). In certain embodiments, a number of different user devices 110 may be associated with a particular user. For example, a particular user may own each of desktop computer 110a, tablet 110b, laptop 110c, and smartphone 110d, and may use such devices to access the one or more functions of server 120 as described herein.

Server 120 may provide one or more functions accessible to user devices 110, as described herein. For example, server 120 may provide users of user devices 110 access to one or more online accounts or account functions through a website, through a dedicated application installed on the user device 110, or through any other suitable means. In providing functionality to user devices 110, server 120 may access or otherwise utilize database 125.

Network 130 may include any suitable technique for communicably coupling user devices 110 with server 120. For example, network 130 may include an ad-hoc network, an intranet, an extranet, a virtual private network (VPN), a wired or wireless local area network (LAN), wide area network (WAN), metropolitan area network (MAN), a portion of the Internet, a portion of the Public Switched Telephone Network (PSTN), a portion of a cellular telephone network, or any combination thereof.

Modifications, additions, or omissions may be made to FIG. 1 without departing from the scope of the present disclosure. For example, FIG. 1 illustrates particular types of user devices 110. However, it will be understood that any suitable type of user device 110 may be used to access the one or more functions provided by server 120. As another example, although illustrated as a single server, server 120 may include a plurality of servers in certain embodiments. Similarly, although illustrated as a single database, database 125 may include a plurality of databases in some embodiments.

FIG. 2 illustrates an example computer system 200 in accordance with embodiments of the present disclosure. One or more aspects of computer system 200 may be used in user devices 110 or server 120 of FIG. 1. For example, each of user devices 110 or server 120 may include a computer system 200 in some embodiments. As another example, each of user devices 110 or server 120 may include two or more computer systems 200 in some embodiments.

Computer system 200 may include a processor 210, memory 220 comprising instructions 230, storage 240, interface 250, and bus 260. These components may work together to perform one or more steps of one or more methods (e.g. method 500 of FIG. 5) and provide the functionality described herein. For example, in particular embodiments, instructions 230 in memory 220 may be executed on processor 210 in order to process requests received by interface 250 using common function modules. In certain embodiments, instructions 230 may reside in storage 240 instead of, or in addition to, memory 220.

Processor 210 may be a microprocessor, controller, application specific integrated circuit (ASIC), or any other suitable device or logic operable to provide, either alone or in conjunction with other components (e.g., memory 220 and instructions 230) functionality according to the present disclosure. Such functionality may include processing application functions using remotely-located common function modules, as discussed herein. In particular embodiments, processor 210 may include hardware for executing instructions 230, such as those making up a computer program or application. As an example and not by way of limitation, to execute instructions 230, processor 210 may retrieve (or fetch) instructions 230 from an internal register, an internal cache, memory 220, or storage 240; decode and execute them; and then write one or more results of the execution to an internal register, an internal cache, memory 220, or storage 240.

Memory 220 may be any form of volatile or non-volatile memory including, without limitation, magnetic media, optical media, random access memory (RAM), read-only memory (ROM), flash memory, removable media, or any other suitable local or remote memory component or components. Memory 220 may store any suitable data or information utilized by computer system 200, including software (e.g., instructions 230) embedded in a computer readable medium, and/or encoded logic incorporated in hardware or otherwise stored (e.g., firmware). In particular embodiments, memory 220 may include main memory for storing instructions 230 for processor 210 to execute or data for processor 210 to operate on. In particular embodiments, one or more memory management units (MMUs) may reside between processor 210 and memory 220 and facilitate accesses to memory 220 requested by processor 210.

Storage 240 may include mass storage for data or instructions (e.g., instructions 230). As an example and not by way of limitation, storage 240 may include a hard disk drive (HDD), a floppy disk drive, flash memory, an optical disc, a magneto-optical disc, magnetic tape, a Universal Serial Bus (USB) drive, a combination of two or more of these, or any suitable computer readable medium. Storage 240 may include removable or non-removable (or fixed) media, where appropriate. Storage 240 may be internal or external to computer system 200, where appropriate. In some embodiments, instructions 230 may be encoded in storage 240 in addition to, in lieu of, memory 220.

Interface 250 may include hardware, encoded software, or both providing one or more interfaces for communication (such as, for example, packet-based communication) between computer systems on a network (e.g., between employee devices 110 and back-end 130 of FIG. 1). As an example, and not by way of limitation, interface 250 may include a network interface controller (NIC) or network adapter for communicating with an Ethernet or other wire-based network and/or a wireless NIC (WNIC) or wireless adapter for communicating with a wireless network. Interface 250 may include one or more connectors for communicating traffic (e.g., IP packets) via a bridge card. Depending on the embodiment, interface 250 may be any type of interface suitable for any type of network in which computer system 200 is used. In some embodiments, interface 250 may include one or more interfaces for one or more I/O devices. One or more of these I/O devices may enable communication between a person and computer system 200. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these.

Bus 260 may include any combination of hardware, software embedded in a computer readable medium, and/or encoded logic incorporated in hardware or otherwise stored (e.g., firmware) to communicably couple components of computer system 200 to each other. As an example and not by way of limitation, bus 260 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 260 may include any number, type, and/or configuration of buses 260, where appropriate. In particular embodiments, one or more buses 260 (which may each include an address bus and a data bus) may couple processor 210 to memory 220. Bus 260 may include one or more memory buses.

Modifications, additions, or omissions may be made to FIG. 2 without departing from the scope of the present disclosure. For example, FIG. 2 illustrates components of computer system 200 in a particular configuration. However, any configuration of processor 210, memory 220, instructions 230, storage 240, interface 250, and bus 260 may be used, including the use of multiple processors 210 and/or buses 260. In addition, computer system 200 may be physical or virtual.

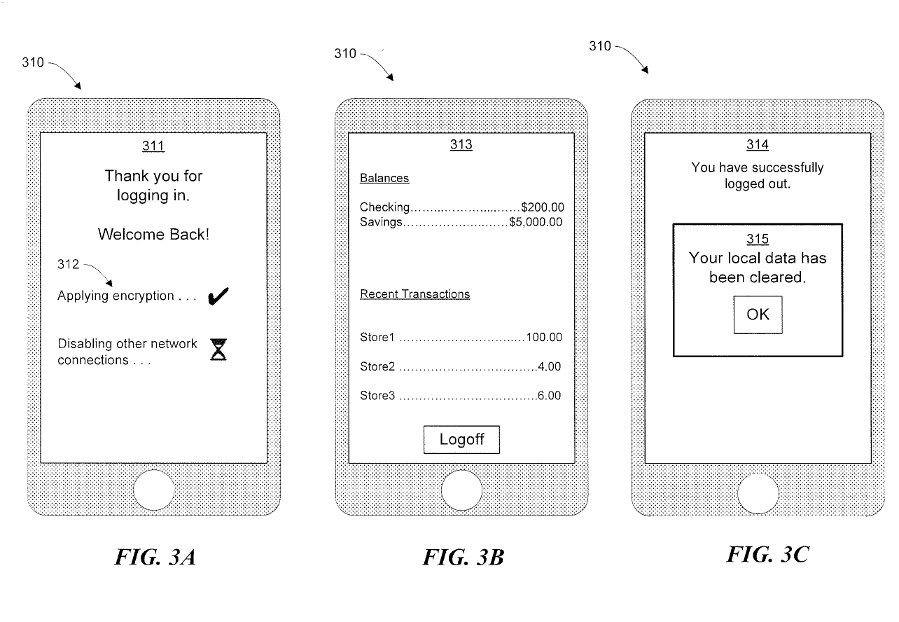

FIGS. 3A-3C illustrate an example user device 310 performing online account security actions in response to sign-on and sign-off events in accordance with embodiments of the present disclosure. In particular, FIG. 3A illustrates an example user interface 311 of a mobile application installed on user device 310 that may be shown to a user after successfully providing login credentials (i.e., a sign-on event). In response to the sign-on event, one or more first account security functions may be performed on the user device 310. For example, as shown, encryption protocols may be applied to communications and local data associated with the mobile application, and communications for other applications installed on the user device may be disabled after a user logs into the mobile application. In certain embodiments, a notification 312 may be provided that indicates that the account security functions have been performed, are being performed, or will be performed. After performing the account security functions in response to the sign-on event, a user interface for the mobile application, such as user interface 313 of FIG. 3B, may be displayed on user device 310 such that the user may interact with the mobile application as she typically would.

Once the user is finished with her session on the mobile applications, she may log out of the mobile application (i.e., a sign-off event). FIG. 3C illustrates an example user interface 314 of a mobile application that may be shown to a user after the sign-off event. In response to the sign-off event, one or more additional account security functions may be performed. For example, as shown, local data associated with the mobile application may be deleted from the user device after the user logs out of the mobile application. In certain embodiments, a notification 315 may be provided that indicates that the additional account security functions have been performed, are being performed, or will be performed.

Modifications, additions, or omissions may be made to FIGS. 3A-3C without departing from the scope of the present disclosure. For example, FIGS. 3A-3C illustrate a particular type of user device 310 performing online account security actions in response to sign-on and sign-off events. However, it will be understood that any suitable type of user device 310 may be used to perform online account security actions in response to sign-on and sign-off events. In addition, although particular types of account security functions are shown as being performed in response to sign-on and sign-off events, it will be understood that any suitable account security functions may be performed in response to sign-on or sign-off events. Furthermore, although notifications 312 and 314 are illustrated as particular types of notifications in user interfaces 311 and 314, respectively, it will be understood that any suitable type of notification may be provided and that such notifications may be provided at any suitable user interface.

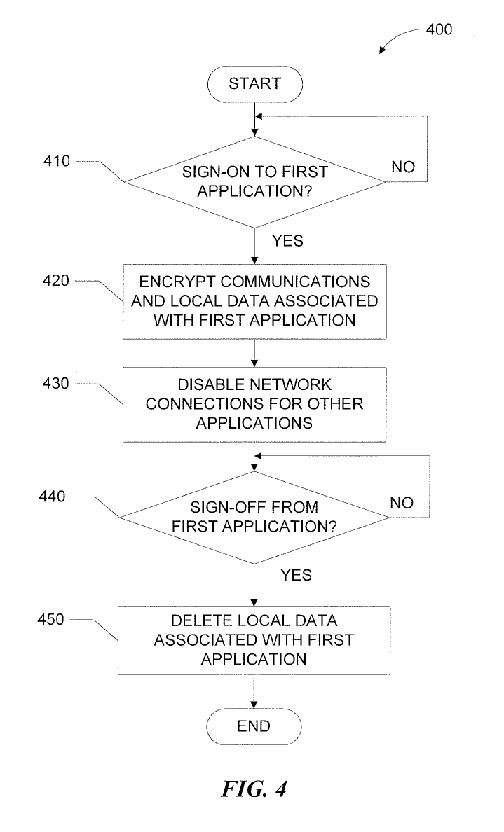

FIG. 4 illustrates an example method 400 for performing online account security actions in response to sign-on and sign-off events in accordance with embodiments of the present disclosure. The method begins at step 410, where it is determined whether a sign-on event for a mobile application of a user device has occurred. If a sign-on event has occurred, then the method proceeds to step 420, where communications a local data associated with the mobile application are encrypted in response to the sign-on event. In addition, at step 430, network connections for other applications of the user device may be disabled in response to the sign-on event. At step 440, it is determined whether a sign-off event for the mobile application has occurred. If a sign-off event has occurred, then the method proceeds to step 450, where local data associated with the mobile application is deleted in response to the sign-off event.

Modifications, additions, or omissions may be made to method 400 without departing from the scope of the present disclosure. For example, the order of the steps may be performed in a different manner than that described and some steps may be performed at the same time. Additionally, each individual step may include additional steps without departing from the scope of the present disclosure.

Although the present disclosure includes several embodiments, changes, substitutions, variations, alterations, transformations, and modifications may be suggested to one skilled in the art, and it is intended that the present disclosure encompass such changes, substitutions, variations, alterations, transformations, and modifications as fall within the spirit and scope of the appended claims.

What is claimed is:

1. A system, comprising:
a memory comprising instructions;
an interface configured to receive an indication of a sign-on event for a first application installed on a user device;
a processor communicatively coupled to the memory and the interface and configured, when executing the instructions, to perform, in response to the sign-on event, one or more first account security functions.

2. The system of claim 1, wherein performing the one or more first account security functions comprises applying encryption protocols to communications and local data associated with the first application.

3. The system of claim 1, wherein performing the one or more first account security functions comprises disabling communications for a second application installed on the user device.

4. The system of claim 1, wherein the interface is further configured to provide a notification indicating that the one or more first account security functions were performed.

5. The system of claim 1, wherein:
the interface is further configured to receive an indication of a sign-off event for the first application; and
the processor is further configured to perform, in response to the sign-off event, one or more second account security functions.

6. The system of claim 5, wherein performing the one or more second account security functions comprises deleting local data associated with the first application.

7. The system of claim 5, wherein the interface is further configured to provide a notification indicating that the one or more second account security functions were performed.

8. A method, comprising:
receiving an indication of a sign-on event for a first application installed on a user device; and
performing, in response to the sign-on event, one or more first account security functions.

9. The method of claim 8, wherein performing the one or more first account security functions comprises applying encryption protocols to communications and local data associated with the first application.

10. The method of claim 8, wherein performing the one or more first account security functions comprises disabling communications for a second application installed on the user device.

11. The method of claim 8, further comprising providing a notification indicating that the one or more first account security functions were performed.

12. The method of claim 8, further comprising:
receiving an indication of a sign-off event for the first application; and
performing, in response to the sign-off event, one or more second account security functions.

13. The method of claim 12, wherein performing the one or more second account security functions comprises deleting local data associated with the first application.

14. The method of claim 12, further comprising providing a notification indicating that the one or more second account security functions were performed.

15. A computer-readable medium comprising instructions that are configured, when executed by a processor, to:
receive an indication of a sign-on event for a first application installed on a user device; and
perform, in response to the sign-on event, one or more first account security functions.

16. The computer-readable medium of claim 15, wherein performing the one or more first account security functions comprises applying encryption protocols to communications and local data associated with the first application.

17. The computer-readable medium of claim 15, wherein performing the one or more first account security functions comprises disabling communications for a second application installed on the user device.

18. The computer-readable medium of claim 15, wherein the instructions further configured to provide a notification indicating that the one or more first account security functions were performed.

19. The computer-readable medium of claim 15, wherein the instructions are further configured to:
receive an indication of a sign-off event for the first application; and
perform, in response to the sign-off event, one or more second account security functions.

20. The computer-readable medium of claim 19, wherein performing the one or more second account security functions comprises deleting local data associated with the first application.
